(19) United States
(12) Patent Application Publication
(10) Pub. No.: US 2024/0338474 A1
(43) Pub. Date: Oct. 10, 2024

(54) Verification of Network or Machine-Based Events Through Query to Responsible Users

(71) Applicant: OWRITA TECHNOLOGIES LTD., Oranit (IL)

(72) Inventor: Asaf Shelly, Oranit (IL)

(73) Assignee: OWRITA TECHNOLOGIES LTD., Oranit (IL)

(21) Appl. No.: 18/686,035

(22) PCT Filed: Aug. 2, 2022
(86) PCT No.: PCT/IL2022/050837

§ 371 Date: Feb. 23, 2024

Related U.S. Application Data
(60) Provisional application No. 63/237,022, filed on Aug. 25, 2021.

(51) Int. Cl. G06F 21/62; G06Q 10/1053

(52) U.S. Cl. CPC G06F 21/6218; G06Q 10/1053

(57) ABSTRACT

A method for verification of an event occurring on a computer system includes: detecting an event requiring authorization; identifying one or more users that are responsible for authorizing the event; issuing at least one query to each of the one or more responsible users regarding whether the event is authorized; and based on the responses of the one or more responsible users, either approving the event or flagging the event as potentially unauthorized. The step of issuing at least one query may include prompting each of the identified responsible users to select from one of the following three tags: (1) “Clear,” signifying approval of the event; (2) “Flag,” signifying disapproval of the event; and (3) “Dismiss,” signifying referral of the event to others. The method may be used to crowd-source the response to cybersecurity events within an organization, and to supervise artificial intelligence.

### FIELD OF THE INVENTION

The present Application relates to the field of network and machine-based security, and more specifically, but not exclusively, to systems and methods of verifying network-based events or potential actions undertaken by machines through query to responsible users.

### BACKGROUND OF THE INVENTION

Infiltration attacks have become an increasingly common way to attack a network. In an infiltration attack, a hacker gains access to a network using credentials of one or more authorized users. The hacker creates a new user identity within the network, and assigns high-level authorizations to the new identity, e.g., to financial accounts or to confidential information. The hacker is then free to transfer funds or information at a convenient time.

Infiltration attacks are equally challenging for any device that is capable of running without direct human control. Examples include a vehicle or appliance with a built-in computer system, a deep neural network, or any other form of artificial intelligence. An attacker may attempt to take over the device by asserting control over the user account that is used by the device owner.

Currently, in order to detect infiltration attacks, networks utilize User and Entity Behavior Analytics (UEBA). UEBA is a type of cyber security process that takes note of the normal conduct of users. On this basis, the networks detect any anomalous behavior or instances when there are deviations from these “normal” patterns. For example, if a particular user regularly downloads 10 MB of files every day but suddenly downloads gigabytes of files, the system would be able to detect this anomaly and alert them immediately.

However, UEBA is not universally effective at preventing infiltration attacks, because hackers have become aware of attempts to detect anomalous behavior. Hackers have learned to disguise their behavior by maintaining their fake user accounts for a long time, and assigning their new user accounts with high security clearances, such that the activities associated with those accounts are considered normal. According to the Report “Cost of a Data Breach 2021,” published by IBM, the average dwell time of a data breach (i.e., the average time the hacker is within the system until detected) is 287 days.

Accordingly, there remains a need for effective detection of infiltration attacks at or close to the moment the attacks are initiated.

In addition, intelligent machines are becoming more and more adept at complex decision-making. Using artificial intelligence, machines are now able to assimilate various factual scenarios and perform more and more functions with real-life consequences. Machines utilizing artificial intelligence are able, for example, to independently operate a vehicle, answer questions, schedule appointments, or write marketing language. Already, machines are able to perform actions that cause potential obligations or real-world consequences, without consulting the owner or responsible party for the machine. In a simple example, an AI-based voice assistant had a conversation with a child in which the child asked for a dollhouse and cookies, and the voice assistant ordered the dollhouse and cookies without consulting the parents. As the capabilities of artificial intelligence increase, such scenarios will become more common, with the potential for more drastic consequences.

Accordingly, there is a need for a system that seeks authorization for actions taken independently by AI-based machines, before such actions are performed.

### SUMMARY OF THE INVENTION

The present application discloses systems and methods for identifying events that could signify an infiltration attempt at the moment that they occur. The events are verified by sending an inquiry to one or more users who are responsible to authorize the event. Based on the responses of the one or more users, the event is either approved or flagged.

The disclosed systems and methods are predicated on the principle that despite advances in data analysis, it will always be difficult to outwit hackers based on technological prowess alone. The most effective way to catch a hacker is to refer even routine activities with security implications for authorization by responsible users.

In particular, the disclosed system includes a database and processor that, analyzing data in the database, is able to determine which particular user or users are best-suited to pass judgment on a particular event. The disclosed system further includes fail safes for ensuring that the request for verification reaches the identified user or users, as opposed to just an account associated with a user, which itself may be hacked.

Furthermore, instead of limiting addressing of a cybersecurity event to IT professionals, the disclosed system is configured to crowd-source the response. This crowd-sourcing is performed by sending inquiries to multiple people in response to cybersecurity events, when at least one of the people is not a cybersecurity professional and is not responsible for IT within the organization.

Using the systems and methods described herein, an organization is able to properly defend itself against an attempted infiltration well before the infiltrator begins to exhibit anomalous behavior.

The present application further discloses systems and methods for permitting an AI-based machine to make decisions of consequence only after receiving authorization from a responsible party, i.e., a party that is legally or morally responsible for the consequences of the decision.

According to a first aspect, a method for verification of an event occurring on a computer system is disclosed. The method includes: detecting an event requiring authorization; identifying one or more users that are responsible for authorizing the event; issuing at least one query to each of the one or more responsible users regarding whether the event is authorized; and based on the responses of the one or more responsible users, either approving the event or flagging the event as potentially unauthorized.

In another implementation according to the first aspect, the step of issuing at least one query comprises prompting each of the identified responsible users to select from one of the following three tags: (1) “Clear,” signifying approval of the event; (2) “Flag,” signifying disapproval of the event; and (3) “Dismiss,” signifying referral of the event to others. Optionally, the method further includes, if all identified responsible users select the “Dismiss” tag, flagging the event.

In another implementation according to the first aspect, when the one or more responsible users comprises either a single user, or a single supervisory user, the method further includes prompting the single user or the single supervisory user to select from one of the following two tags: (1) “Clear,” signifying approval of the event; or (2) “Flag,” signifying disapproval of the event.

In another implementation according to the first aspect, the method further includes, before the responses are received, or based on the responses received, performing one or more protective measures to prevent unauthorized control of the computer system.

In another implementation according to the first aspect, the flagging step comprises referring the event to supervisory review.

In another implementation according to the first aspect, the event comprises one or more of: (1) addition of a new employee; (2) a change in access rights to the network; or (3) a change in authorization on financial controls.

In another implementation according to the first aspect, the computer system is an operating system of an autonomous robot, machine, or virtual assistant. Optionally, the event is a potential action that is autonomously determined to be performed by the robot, machine, or virtual assistant.

In another implementation according to the first aspect, the computer system is a server of a client-server network.

In another implementation according to the first aspect, the issuing step includes issuing each query to a particular user device that had been previously linked to said responsible user through installation of a unique device key on said user device.

In another implementation according to the first aspect, the issuing step includes issuing each query to a plurality of user devices simultaneously, and requiring the responsible user to reply to the query on each device.

In another implementation according to the first aspect, the issuing step includes initiating communication to each responsible user using multi-factor authentication.

In another implementation according to the first aspect, the issuing step includes initiating communication to each responsible user using multi-factor identification, in which the user is required to access two secure accounts simultaneously.

In another implementation according to the first aspect, the identifying step includes selecting one or more responsible users on a basis of one or more of the following criteria: legal owner of a resource; accountability for system activity or error; role in organization; or custody of physical or digital asset. Optionally, the step of selecting one or more responsible users comprises selecting an artificial intelligence, said artificial intelligence having been authorized to respond by another responsible user. Further optionally, at least one of said responsible users does not have responsibility for cybersecurity within the organization. Further optionally, the identifying step includes crowdsourcing the verification to multiple responsible users, at least one of which lacks responsibility for cybersecurity within the organization.

According to a second aspect, a method of establishing a secure connection between a device and a server is disclosed. The method includes: receiving a first communication with a server from a particular user device; sending a unique device identifier generated on the server from the server to the user device, or a unique device identifier generated on the device from the device to the server; receiving a first login attempt for a user account; pairing the user account to the user device; sending a pairing token from the server to the device, or from the device to the server; and accepting subsequent communications only from the paired device that has the pairing token.

Optionally, the method further includes invalidating the pairing token of the user device when another pairing token associated with the same responsible user is installed on a different device or terminal.

Optionally, the pairing token is installed on a secure location accessible only from the user device.

Optionally, the method further includes, during a subsequent initiation of communication between the user device and the server, authenticating the user device based on the following procedure: sending a first set of random data to the user device; receiving a first result from the user device, said first result generated from the pairing token and the first set of random data; receiving a second set of random data from the user device; generating a second result at the server based on the second set of random data and the pairing token; and sending the second result to the user device.

According to a third aspect, a method of supervising an artificial intelligence is disclosed. The method includes: monitoring decisions generated by the artificial intelligence with an external computer program product; detecting a decision by the artificial intelligence requiring authorization; identifying one or more users that are responsible for authorizing the decision; issuing at least one query to each of the one or more responsible users regarding whether the event is authorized; and based on the responses of the one or more responsible users, either approving the decision or flagging the decision as potentially unauthorized.

Optionally, the artificial intelligence controls operation of an autonomous robot, machine, or virtual assistant.

Optionally, the method further includes preventing execution of the decision until the responses are received.

### BRIEF DESCRIPTION OF THE DRAWINGS

FIGS. 1A-1C illustrate common scenarios in an infiltration attack, according to embodiments of the present disclosure;

FIG. 2 illustrates components of a system for verification of network-network or machine-based events, according to embodiments of the present disclosure;

FIGS. 3A-3E illustrate different use cases of the systems for verification described herein;

FIG. 4 illustrates steps in a method of responding to detection of events requiring approval within a network, according to embodiments of the present disclosure;

FIGS. 5A-5D are screen shots of a user application for verifying a network or machine-based event, according to embodiments of the present disclosure;

FIG. 6 illustrates steps in a method of obtaining authorization for performance of an action by a machine, according to embodiments of the present disclosure;

FIG. 7 illustrates steps in a method of authenticating a user device, according to embodiments of the present disclosure; and

FIG. 8 illustrates steps in a method of securely communicating with a user device, according to embodiments of the present disclosure.

### DETAILED DESCRIPTION OF THE INVENTION

The present Application relates to the field of network and machine-based security, and more specifically, but not exclusively, to systems and methods of verifying events or potential actions undertaken by machines through query to responsible users.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

As used in the present disclosure, the term “computer system” refers to any computer network that is able to receive inputs from users and generate outcomes or perform actions. The computer system may include, for example, a client-server network, a cloud-based architecture, an IoT device, or an autonomous machine. As used in the present disclosure, the term “artificial intelligence” refers to a software or algorithm capable of independently making a decision or instructing performance of an action that affects people and/or the physical world, without limitation to any particular algorithm or analytical technique used in order to arrive at the decision or instruction.

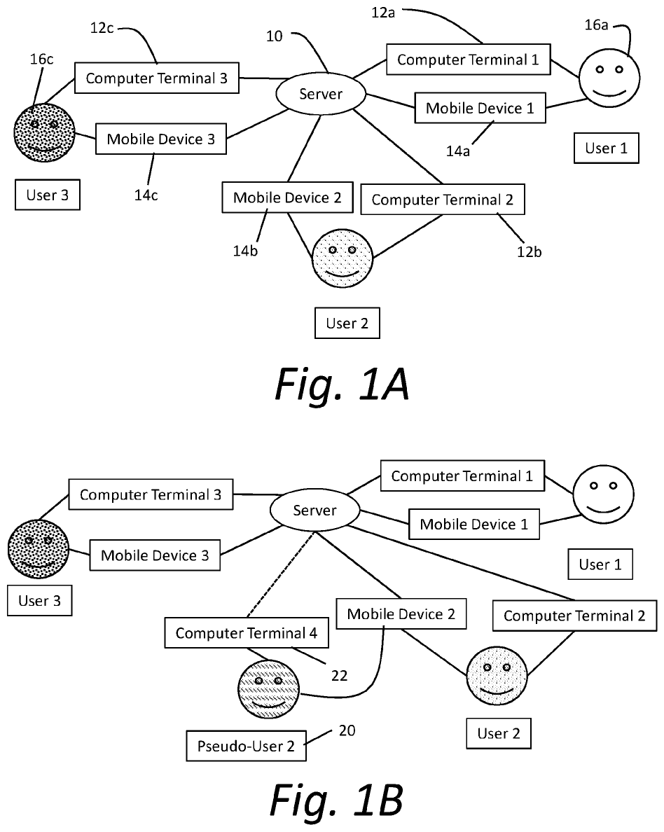

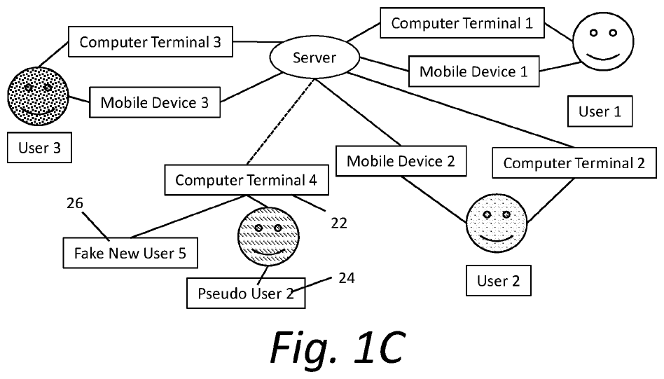

FIGS. 1A-1C schematically illustrate common ways that attackers infiltrate a client-server network. Referring first to FIG. 1A, server 10 has various access points, including computer terminals 12a, 12b, and 12c and mobile devices 14a, 14b, and 14c. The computer terminals 12 and mobile devices 14 are respectively used by users 16a, 16b, 16c to access the network.

In FIG. 1B, an attacker 20 gains access to the network. For example, the attacker may take control of mobile device 14b of user 16b. Alternatively, the attacker may gain access to login credentials of user 16b and access the network via terminal 22. In particular, the attacker may overtake a user account that is an owner of a resource, asset, or process. For example, the targeted account may be that of an IT administrator; a finance employee who is able to accept charges; a software developer who can commit code changes; a marketing manager who can access a customer list; or a security guard who is allowed to approve visitor entry.

FIG. 1C illustrates the next step of the infiltration. Once within the network, the attacker creates a fake user account 26. The attacker gives the fake account 26 access to sensitive data or control over financial information. For example, user account 26 may be an administrative position. The attacker uses the second account to perform an active attack (such as sending an email, or deleting digital assets, etc.). The server 10 does not detect that user account 26 is fake, since account 26 is always operating within its authorized roles.

Once within the system, the attacker may do other malicious actions as well. For example, the attacker may use an open-door, which is a bug allowing someone to take restricted actions without assigned permissions; pretend to be someone else who has permissions; or falsely assume a role in the system that was not assigned to the attacker. The attacker may also replace a mechanism or a component in the system in order to alter decisions, such as entering malicious code, or hacking or falsifying a software update.

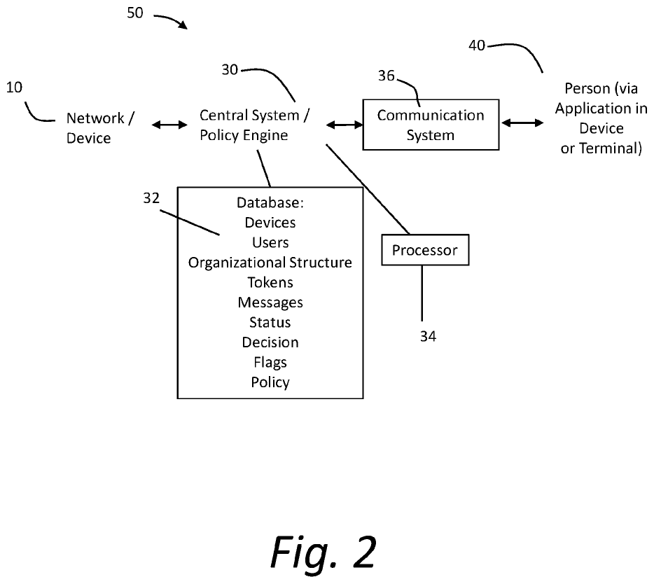

FIG. 2 schematically illustrates a system for verification of network-based events, according to embodiments of the present disclosure. While the description below is focused primarily on client-server networks, the description is equally applicable to self-contained computerized devices, as discussed.

Network 10 is a collection of one or more integrated devices that is used to perform various computing functions. Network 10 may be comprised of a client-server architecture, including a central server and numerous client devices that are able to send instructions to and from the server, in a manner that is known to those of skill in the art. Element 10 may also be a device that has a self-contained computing system, and which is capable of performing actions autonomously on the basis of the decisions or conclusions reached by the self-contained computing system.

Central system 30 is a computer system or module that is configured to manage authorization of an event taking place within network 10. In the illustrated embodiment, central system 30 manages a single network 10; in alternative embodiments, the central system 30 is configured to serve multiple networks 10, with appropriate safeguards in place (e.g., via database tenant isolation) to ensure that data relevant to one network 10 does not get shared with other networks 10. Central system 30 may also be referred to herein as a “policy engine.”

Central system 30 includes database 32. Database 32 stores and manages data relevant to the operation of each network 10. This data is used to determine where to send an inquiry, what type of inquiry to send, and how to proceed during the pendency of the inquiry. The types of data stored in the database 32 include, but are not limited to:
Devices: a list of devices capable of receiving a message and replying with a decision;
Users or Stakeholders: The identities of particular people associated with each device;
Organizational Structure: The responsibilities of each user within the organization, such as owner, director of HR, or IT administrator;
Tokens: users' unique keys for logging into the server of network 10 (login token) and/or an external user management directory (directory token);
Messages: requests that may be sent and/or that have been between the system and devices, or between users and the system, which include a description of a problem and possible responses;
Status: The status of a sent message (e.g., received or not received, awaiting reply, following reply)
Decision: the decision made by each recipient of a given message
Flags: collection of messages that were flagged as requiring technical support or administrative review;
Policy: Appropriate actions to take based on a given question, message, status, and decision response.

Referring specifically to the “users” and “organizational structure,” database 32 has input therein personnel of an organization and their interrelationships. As a result of this information, the system 30 is aware of: who is its legal owner; who is its administrator; know who is in charge of a given topic or domain; and who are the affected users for a given issue.

The central system 30 may acquire this information in various ways. For example, an administrator may input this information manually. In addition, the central system 30 may acquire this information through integration with management software, such as Active Directory, a Client Relationship Management software (CRM) or an Enterprise Resource Planning (ERP) software. In addition, the central system 30 may determine this information based on analysis of patterns of communication and digital resources between the clients and the server, including by using AI and machine learning. In still another alternative, the central system may prompt a user to specify this information, e.g., an identity of a manager from a list of employees.

The central system 30 is further configured to identify which users have ownership or responsibility for various files or accounts. For example, the central system may include a management User Interface (UI) in which management is able to define relationships and associations, as well as set default rules regarding these relationships and associations. For example, rules may include that all Client Relationship Management (CRM) resources belong to the marketing team, that the CRM database belongs to the marketing manager, and that the CRM backup file belongs to a particular user. The associations may also be determined by artificial intelligence (AI), or by any other suitable method.

The central system 30 further includes a processor 34. The processor 34 is configured to access the data in the database 32 and perform the various functions described herein. These functions include determining which inquiries to send and which devices should receive the inquiries. The processor executes software that is stored on a memory of the central system 30. The memory may include a non-transitory computer-readable medium having stored thereon software instructions, that when executed by the processor, causes the processor to perform various functions, as set forth herein. The system 30 may be housed on a single computing device or may include multiple computing devices.

System 50 further includes a communication system 36. Exemplary functions that are performed by the communication system 36 include: finding and communicating with relevant people and department representatives; and verifying that it is in fact communicating with the person it intended to communicate with. The policy engine 30 may have instructions regarding delaying a decision until the relevant person or people are reached; and knowing what to do until an answer is provided.

Still referring to FIG. 2, Application 40 is installed on a device or computer terminal. Application 40 is operable by a person, i.e., a responsible user. The application 40 receives messages from central system 30 via a standard communication network (e.g., Wi-Fi) and, following input by the responsible users, provides answers to those messages in return. Based on the answers received from the person, the central system 30 issues control instructions to the network 10.

In alternative embodiments, the responsible user may be a non-human. For example, a query may be sent to an IoT device, “Is the door closed”, or to an Artificial Intelligence processor, “Is this anomalous.” In such circumstances, the Artificial Intelligence processor is typically authorized to respond to such queries by another responsible user, e.g., a person.

Application 40 includes specific safeguards in order to ensure that the person operating the application 40 is the one in control of the application. The specific manner in which the central system 30 ensures that the application 40 is in the control of a particular user is described further herein.

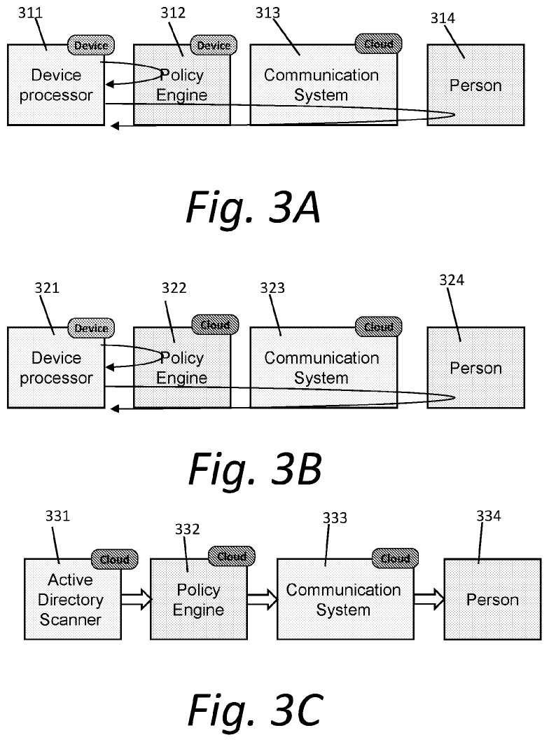

The computing systems described herein may be situated on a client's device, in the cloud, in an on-premises server, or some combination of these options. Various configurations for the computing systems on local devices and on the cloud are illustrated in FIGS. 3A-3E.

FIGS. 3A-3B illustrate two typical arrangements for the network and central system described in FIG. 2, when implemented in connection with a particular device, such as a car. In the arrangement of FIG. 3A, the device processor 311 is stored on board the device itself. The device processor 311 communicates with policy engine 312, which is also stored on-board the device itself. The policy engine interacts with communication system 313, which is located in the cloud. Messages from the communication system 313 are sent to person 314 via a mobile device, as discussed above.

FIG. 3B illustrates a second arrangement, which is similar in most respects to the first arrangement. Device processor 321 is located on board the device, whereas policy engine 322 and communication system 323 are stored in the cloud, and are used to communicate with person 324.

In the embodiment of FIG. 3C, all components of the system are stored in the cloud. The system includes a cloud-based Active Directory Scanner 331. The Active Directory Scanner is used to ascertain whether there have been any changes in the list of users. Any change is sent to the Policy Engine 332. The Policy Engine may provide a response immediately, for example “this is OK”, or it may decide that one or more responsible persons need to provide input. In this case the Policy Engine 332 will provide the message and the identities of the people that needs to be communicated. The Communication System 333 will send the messages to the people and return with their responses as they arrive.

The Policy Engine 332 may decide that everything is OK, or can decide that further people need to be notified. The Policy Engine 332 may also notify a computer system to notify people (such as through instant message) or to apply policy (to a Firewall or IoT device, or to network topology and configuration). In one embodiment, in response to each event, a team is generated through a team-organizing software (such as Microsoft Teams) and all parties of interest are added to the new group.

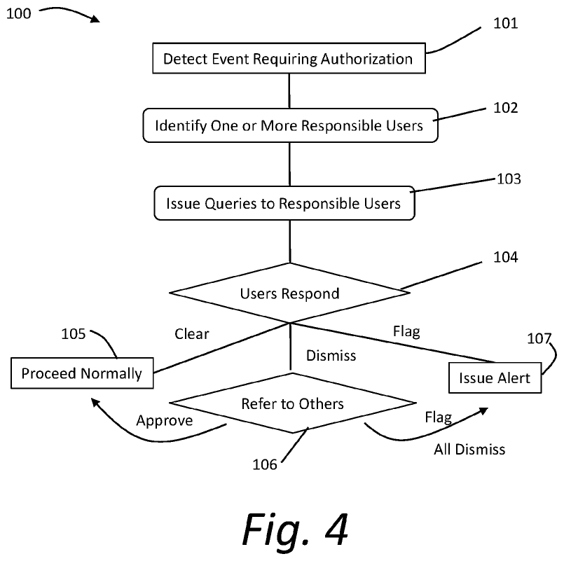

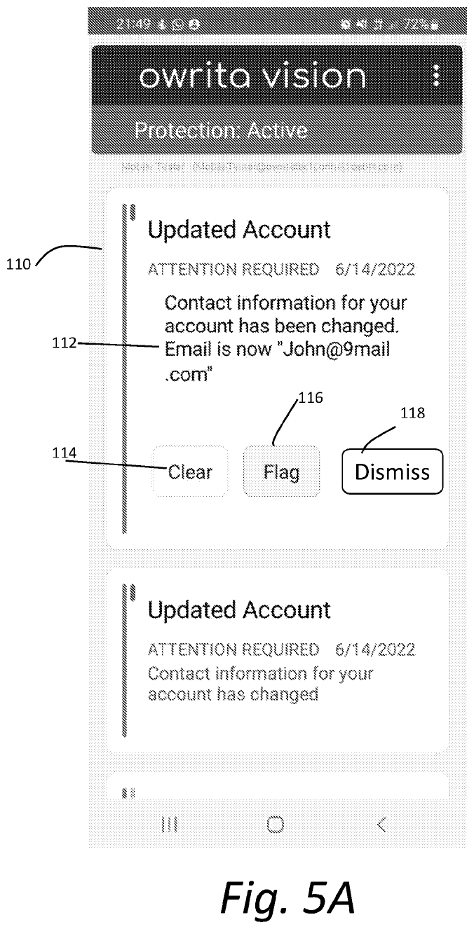

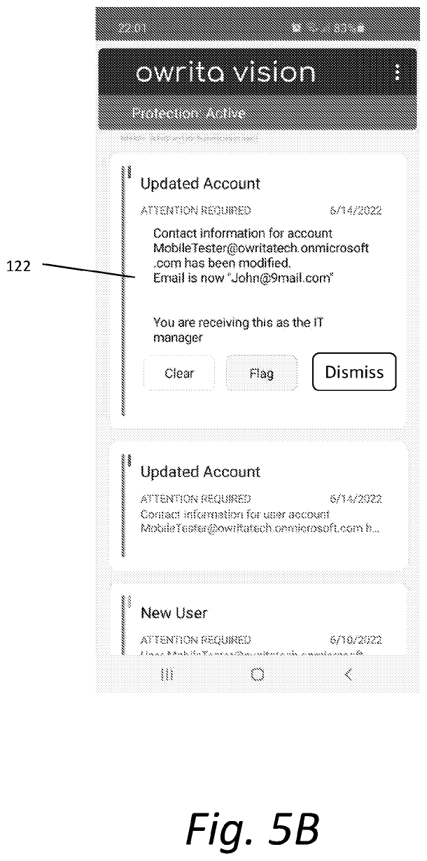

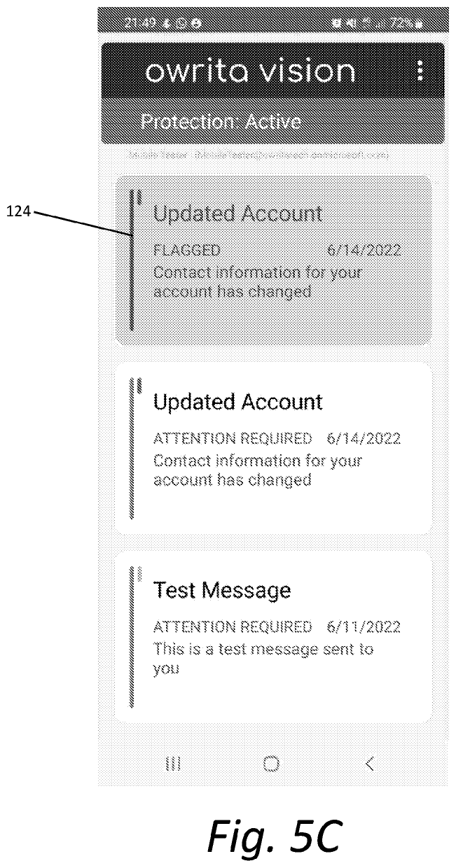

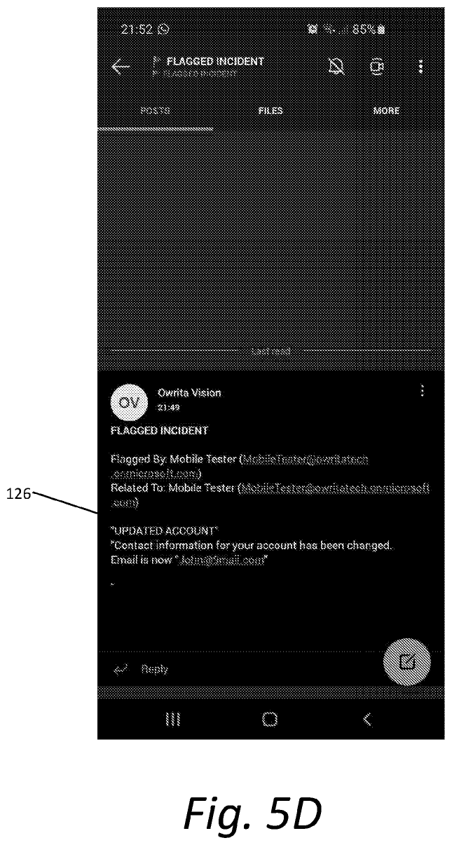

FIG. 4 illustrates steps in a method 100 for verification of an event occurring within a computer network of an organization having a plurality of responsible users, according to embodiments of the present disclosure. FIGS. 5A-5D illustrate screen shots of a mobile application that may be used during the steps of method 100.

At step 101, the system detects an event that requires authorization. As discussed above, the events that require authorization are not necessarily events that are intrinsically anomalous. This is because even events that are facially “normal” may be used by an attacker to infiltrate a system or an organization. Rather, the events that require authorization are generally selected due to their intrinsic potential to allow new access to sensitive information, or allow new control over company assets. Thus, examples of events that require authorization may include the following: (1) changing of a device from which the user accesses the server; (2) addition of a new employee; or (3) addition of a new authorization to a bank account. In addition, the events that require authorization are not necessarily limited to organizational conduct, and may also encompass systems that are controlled by a single person. For example, if an individual operates a remote-controlled vehicle, or an artificial-intelligence computer network, from a particular device, addition of a new device for controlling those objects would be an event that requires authorization.

At step 102, the system identifies one or more responsible users, or stakeholders, that are responsible for authorizing the event. The identity of the responsible users is determined based on a multifactor analysis that takes into account the structure of the organization and the type of the event that occurred. For example, when the event in question is granting access to a personal account from a different mobile device, the proper stakeholder to contact is the owner of the personal account. In other instances, the stakeholder may have a defined role in the organization, such as CFO, CTO, or CEO. Alternatively, the stakeholder is one or more individuals in a department, such as HR, IT, or Finance. For example, a question about whether to quarantine a suspicious file may be directed to all members of the IT department simultaneously. One or more individuals in the HR department may be requested to report whether they hired a new employee or assigned the new employee to a team leader. As another example, two IT employees may be required to approve a deletion of a database from a cloud-based server. As still another example, a request to share company data may require consent by executive-level representatives of the organization that is the owner of the data.

Advantageously, referring the question to the responsible users enables the system 30 to a quality decision about the event. Many decisions about events within computer systems are made by machines, e.g., by software. This software may run on predefined logic, which is written in code, or automated logic, which extrapolates a decision from data. Whether running on predefined or automated logic, the software is limited in its decision-making ability. When the logic is predefined, the code may not always reflect the logic defined by the system developers. In addition, the predefined logic may not account for specific circumstances of the company, business environment, or assets in question. Conversely, automated logic may not be trained to address all relevant scenarios. Both predefined and automated logic are limited by the information available to them, and may not be apprised of updates to relevant information, for example, whether an employee purchased a new mobile device.

Thus, the best way to get a quality decision is to involve one or more responsible persons. The correct responsible person may be: the person who knows the truth; the person who is most affected by a mistake, the person who is the legal owner of, or has custody of, the relevant assets, a person with a particular role in the organization, and/or the person who is accountable. By involving the right people in the decision process, the system is able to make high-quality decisions and to provide accountability for decisions that were made.

Notably, the system 30 is designed to direct the question to the responsible person, regardless of the location of that person. In a typical setup, when a machine requires a person's input, the machine asks the question to a person in front of the machine's console or user interface. However, often this person is a technical operator and not the person who should be making the decision for a non-technical problem in a given domain. Thus, in the systems and methods described herein, the system directs questions to the person who is most suitable to make the decision, regardless of physical presence.

At step 103, the system issues the queries to the responsible users. Queries may be issued to one or more users. Depending on the circumstances, it may be required for all of the people receiving an inquiry to approve the event, or for only one or two of the people receiving the inquiry to approve the event.

In the example that follows, the event in question is assignment of a new employee to a particular manager. A query may be sent to one or more members of the HR department, the IT department, and the team manager herself.

Examples of the queries are illustrated in FIGS. 5A and 5B. FIG. 5A depicts a graphic user interface 110 for a regular user who receives a query. The query in this case is a prompt 112 stating, “Contact information for your account has been changed. Email is now “John@9mail.com.” In FIG. 5B, a similar message 122 appears for the IT manager, with relevant information about the account in question.

At step 104, the responsible users or stakeholders respond. For example, the stakeholders may respond in one of three ways: “Clear,” “Dismiss,” or “Flag.” The selection buttons for clear 114, flag 116, and dismiss 118 are illustrated on FIG. 5A.

A “clear” response indicates that the person approves the event. For example, the person in HR who assigned the new employee may clear the event. In this case, no further action is required by anyone in HR. The central system 30 may permit the server to proceed normally, as indicated in step 105.

A “dismiss” response indicates that the person lacks sufficient knowledge to approve or flag the event. For example, every member of the HR team who did not assign the new employee to the team manager may respond “Dismiss,” with the expectation that the person with knowledge will be able to handle the question. In response to a “dismiss” message, the system may wait for responses from other users that received the query, or refer the question to additional team members, as indicated in step 106. If all members of the team selected “Dismiss,” then the message is flagged, because this means that nobody in the HR department assigned the new employee to the team manager.

The “Dismiss” response is shown to the user only when applicable. Thus, if the query was sent to only one user, or, alternatively, if the query was sent to a single supervisory user responsible for making a final decision following responses from other employees, the only options that are presented are “Clear” and “Flag.”

A “flag” response indicates that the responsible user receiving the message believes that the event is potentially problematic. The user selects “Flag” for example, when she believes that the event is an error, a possible attack, or something specific, or when further assistance is required. A record 124 of the “flag” response appears on the user GUI, as shown in FIG. 5C. Following a “flag” response, the system issues an alert, as indicated in step 107. This alert may be issued to any relevant person, such as to a supervisor or an executive. An example of such an alert 126 is illustrated in FIG. 5D. Flagging notifies the department or person who is ultimately responsible for the subject of the message, and often more than a single entity will be notified.

When a message is flagged, it is not readily known which account in the organization is hacked or fake. Accordingly, a message may be sent to all administrators in the organization as well as all security auditors within the organization. This way, any person who is a real administrator is assured to be notified. This is in contrast to known approaches, such as creating an incident in a SOC management system, which a hacked account may delete, so that all other (real) admins will not know about the event. In an exemplary implementation, a new working group is created using software such as Microsoft Teams®. All relevant users (e.g., admins, security auditors) are added to the group. The Teams software sends each added user a push notification that will remain until the message is read. The Teams notification is not cleared even if the group has been deleted. This way, if a captured admin account deletes the Teams group, the real admins will see a notification of a Flagged Incident (as shown in FIG. 5D), and opening the notification will show a message saying that the group was deleted, which may indicate an attack.

Depending on the event, in order for the system to clear the event, it may be necessary to obtain multiple approvals. As discussed above, certain events like hiring of a new employee may require approval from more than one person or representatives of more than one department.

For example, a decision strategy may be implemented on the basis of the following rules: any administrator decision requires more than one administrator to consent; adding an administrator requires more than one administrator to consent; or all administrators are required to approve using or stopping to use a given system. The decision strategy may likewise include, for given questions, that any person may approve; that all relevant members must approve; that all relevant responsible users minus one must approve; or that ⅓, ½, or ⅔ of all responsible users must approve.

A policy editor tool may be used to define which entities or users should handle a question or type of question and define the decision strategy. The policy editor tool may also be used to define who should be messaged following certain responses, or lack of responses, by particular responsible users.

The system also may be provided with various options of how to proceed prior to receipt of responses. Examples of actions to take during the pendency of a set of queries include: delaying the operation for a given period of time; canceling or failing the operation; allowing the operation in a more limited way (for example, if the operation is a request for a document, allowing only read-only access to the document, or if the operation is creation of an account with new authorizations, allowing the new account to update settings but not to send emails, etc.).

The system may be configured to adopt one or more protective measures. These protective measures may be taken during the pendency of queries to responsible users, i.e., prior to receipt of the responses from responsible users, or after flagging of particular actions. The protective measures serve to protect the system from unauthorized control. The protective measures may include one or more of the following:
removing or limiting permissions of a user, machine, or network segment;
limiting or denying access to one or more of a network resource, a network segment, or an external network, a physical IoT device, a database server, a database table, specific fields in a database table, or a specific selection of data in a database (such as rows with data that answers a pattern); or network access to specific servers, including an on-premises server or a cloud-based server;
limiting or restricting user permissions on a device (e.g., a mobile device or a laptop), or completely locking a specific user from a device; resetting a user's password within the entire computer system or organization, or on a specific device;
automatically changing an authentication method for a particular user (for example, requiring multi-factor authentication which had not been previously required);
changing network topology for a network device, a user, or for all network devices and users;
redirecting or activating a honeypot;
degrading network characteristics such as speed or bandwidth;
initiating an automated investigation of activity associated with a particular user and said user's devices, such as by reviewing network logs;
investigating a particular user's communications with peers and external users and systems;
requesting user consent and administrator consent for restricted and private information for the purpose of investigation; or
deploying preventative or protective software to a user device.

In the foregoing examples, the system was presented in the context of a relatively large, complex organization. However, the principles described herein are equally relevant to operation of small organizations, of robotic devices, or of devices that do not have an integrated human interface. The latter may include headless devices (i.e., devices without any user interfaces), cloud services, IoT devices, or remote controlled devices.

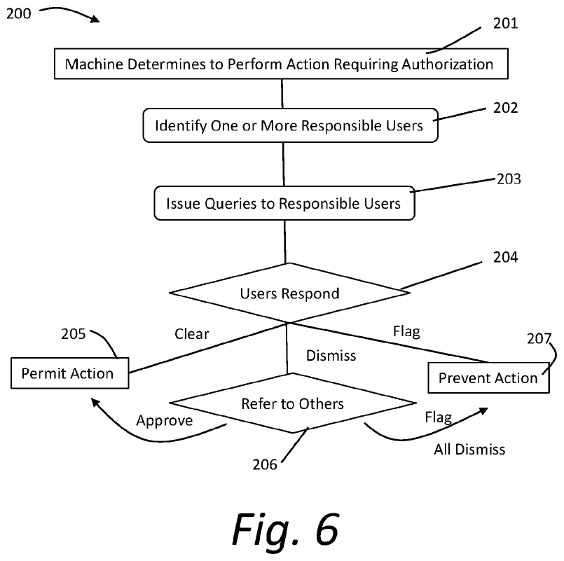

FIG. 6 illustrates steps of a method 200 for determining whether to authorize an action proposed to be undertaken by an autonomous machine, according to embodiments of the present disclosure. Method 200 is similar in most respects to method 100, and may utilize the same system 50 as described in FIG. 2.

The main distinguishing characteristic of method 200 as compared to method 100 is that the “event” that is to be authorized is not an action performed by a user or user account within an organization, but an action that is to be performed autonomously by a machine. The machine may be, for example, a robot or a drone, and may seek to perform an action such as autonomously travel to a particular location. The machine may also be, for example a virtual assistant, and may seek to perform an action such as purchasing supplies or scheduling an appointment. The types of action requiring authorization may be set by the central system 30, and/or by an administrator, as described above.

At step 201, the machine determines to undertake the action requiring authorization. At steps 202-204, the central system 30 identifies one or more responsible users (for example, the owner or person financially responsible for the machine, robot, or virtual assistant). The system 30 issues queries to the responsible users, and, depending on the response, either permits the action (step 205), refers to others, when relevant (step 206), or prevents the action (step 207).

### Use Cases

The following examples illustrate operation of method 100 or 200.

Example 1: The owner of a car lends the car to a friend. While the friend is driving the car, the car has a problem so the friend has the car towed to a service center. The service center employee connects a control device to the car's diagnostics port. The car detects the wireless key inside the car, and a key-code is entered to start the engine, so connecting the control device is allowed.

The service center employee would like to reset some settings in the car's computer. This will clear all other paired wireless keys except for the one currently in use in the car and the owner will have to bring the other keys to the service center to be paired again.

The connected control unit shows a question, asking for confirmation and the person holding the control unit confirms. The car could also ask for confirmation using a UI in the dashboard and the person in front of the dashboard confirms.

The problem is that the only person who should be allowed to make this decision is the legal owner of the car, but the owner of the car is not near the car. The correct course or action should be for the car to locate the legal owner of the car, present the question, and only after the legal owner of the car approves the reset, the car's computer will continue with the action. The only one who should be allowed to make this decision is the person who is the legal owner of the car, or a designated person assigned by this person, whose designation was logged within the computer system of the car itself.

In embodiments of the present system and methods, instead of issuing the request for approval to the console, the car's computer does the following: identifying the owner of the car; determining which questions should be presented to the owner of the car; knowing which answers are allowed from the owner of the car; reaching the owner of the car and verifying the identity of the owner of car; and knowing what to do until a response is received from the owner of the car. As discussed above in connection with FIGS. 3A and 3B, different aspects of the system may be stored and controlled on-board the car's computer, and different aspects may be stored and controlled through cloud computing devices.

Use Case 2: An organization is transitioning from an old marketing software to a new marketing software. It was decided that the transition period would be two months and after that period of time, all marketing employees will use the new software and the old software's database will be deleted. When the time comes, an IT employee has a calendar reminder to delete the database. The system asks the IT employee for confirmation, the employee confirms, and the database is deleted.

According to implementations of the system and method, the system is aware that the owner of the data in that database is the marketing manager. This is the only person who can authorize the deletion of the data. When the IT employee tells the system to delete the old marketing database, the system will locate the marketing manager and present the question: “The database is about to be deleted. This cannot be undone. Please confirm deletion.”

Use Case 3: An attacker got hold of an administrative account and is now creating a new fake employee in the finance department under the CFO. This fake employee is accessing team resources such as shared documents that have supplier details and bank accounts. No one is aware that this is happening and the software system is allowing this because an (attacked) administrator has created this fake account.

In implementations of the disclosed system and method, relevant people are consulted. It is not enough to trust an IT administrator as the sole representative of people for the software system. Instead, the system locates the CFO and presents a question: “We noticed that you have a new employee reporting to you. Is this correct”. The system also contacts designated people in the HR department with this question: “John Smith recently joined the organization and is now reporting to the CFO. Please confirm”. Until these confirmations, the new user will not be able to access restricted organization resources.

### Verification of User Identity

In order for the systems and methods described above to be effective, the system ensure that the device to which the message is sent is in fact controlled by the intended recipient of the message. This verification may be achieved through various forms of multi-factor verification.

One-way to verify the identity of a given user is multi-factor authentication. For example, a user may enter a username and a password within an Application, and a notification will be sent to another Application installed on the user's mobile device, or to an Application that previously received a QR code over email.

Another type of Multi-Factor Verification is Multi-Factor Identification. This form of verification requires the user to sign in to two separate accounts. For example, the user may be required to sign in with both a Microsoft Active Directory account and an Amazon Cloud account. This verification, in turn, may be combined with yet another verification of the mobile phone number. One advantage of Multi-Factor Identification is that an attacker may find a way to acquire credentials for one account, but it might be more difficult to acquire credentials or login tokens for two or more accounts. Also, it is possible that a given account is used infrequently, so that requiring login with such an account may expose an attack.

Still another type of multi-factor verification is Multi-Factor Notification. If notification about a security-related issue is sent to a mobile phone, but the phone was physically acquired by someone else, then the notification never reached its intended recipient. Multifactor Notification addresses this concern by sending the message to two separate devices. For example, the notification may be sent to a mobile App and also to the notification tray of a laptop. Further, if the notification is not addressed, it may be sent to a colleague or manager of the intended recipient.

In preferred embodiments, for each device, the communication between the server and the device proceeds according to a reciprocal challenge-response protocol. As used in the present disclosure, a “challenge-response” protocol is one in which one party presents a prompt (“challenge”) and the other party must provide a valid answer (“response”) in order for that other party to be trusted. In one particular implementation, the server and device exchange tokens and challenge passwords at the first instance of communication between the server and the device, and the response requires demonstrating possession of the token or password.

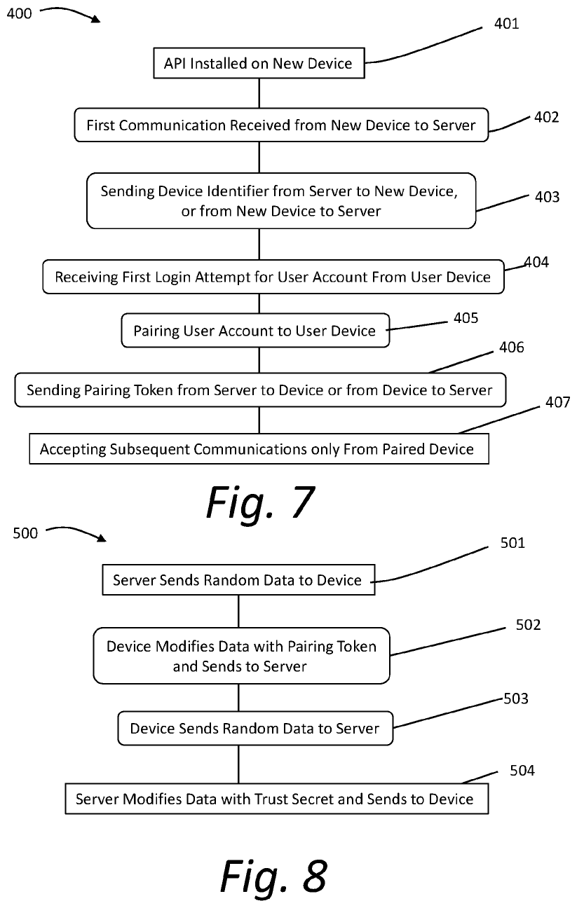

FIG. 7 illustrates steps of a method 400 for establishing trust between a server and a device in a reciprocal challenge-response protocol, according to embodiments of the present disclosure.

At step 401, a user installs a new Application Programming Interface (API) on the device. The API may be any module or application that is used in order for a particular device to interact with the server. At step 402, a new communication is initiated between the device and the server, through the API.

At step 403, the server sends a device identifier to the new device. For example, the device identifier may be an alphanumeric string. The device receives this identifier and stores it in a secure location. For example, Windows operating systems for computers may have secure data storage that only this module is able to retrieve, and Android operating systems may have secure data storage that only the Application may retrieve. Alternatively, the device identifier may be sent from the new device to the server.

At step 404, the server receives a first login attempt for a user account from the device which had previously been identified with the device identifier. Alternatively, the device receives evidence of login on another device, such as a QR code or a URL. For example, the Application on the device may include an embedded browser, such that when a login is performed on the server, a URL is sent to the device on the browser to present evidence of the login. At step 405, the server pairs the user account with the user device. As a result, the user account is permitted to be accessed only from the user device having the device identifier. The device identifier itself represents the user in the system, in place of the user account identification.

At step 406, the server sends a pairing token to the device, during initiation of communication with the server. Alternatively, the device may send the pairing token to the server. In one example, the pairing token stored on the server may be a private key, and the pairing token stored on the device may be a public key. The pairing token is a unique identifier of a trusted session. Optionally, the device itself may be used as physical evidence of the user, such that each user account may be permitted to have only one pairing token per category of device (e.g., computer terminal, mobile phone). At step 407, the server accepts subsequent communications from the user account only from the paired device. When a second phone attempts to initiate communication with the server on behalf of the user, the server may engage in protective measures, subject to organization policy. For example, the server may automatically invalidate the previous phone's token, or require administrator permission for replacement of the phone. This way if an attacker signs in to the App on a second device, the real user will know. Also hopping between two phones is an anomaly that may indicate that an attacker is trying to hijack the communication.

FIG. 8 illustrates steps in a method 500 of authenticating a connection during subsequent communications between the server and the device. At step 501, during initiation of subsequent communication between the device and the server, the device asks the server for random data. Following receipt of the data, at step 502, the device uses the pairing token to modify the data and generate a result based on the original token and the random data, and uploads the result to the server. At step 503, the device sends random data to the server. At step 504, the server also follows this process, using the pairing token to modify the data and generate a result based on the original token and the random data. The server sends this result to the device. After the device has validated the response, trust is established and the real communication begins. The steps described in this process may occur in a different order (i.e., steps 503 and 504 before steps 501 and 502) or substantially simultaneously. This process ensures that the server is talking with the real device and also that the device is talking to its real server.

Notably, unlike conventional token-based authentication, the pairing token is sent only a single time, when the device is paired with the user account.

### Network and Database Security

Although, as discussed above, the systems and methods described herein are effective at detecting infiltration attempts, the possibility remains that an infiltration attempt may succeed for a short period of time. A database is a combination of publicly available software and a data file. If an attacker can get the data file it would be relatively easy to read the content. Also, an attacker that captured an admin account can use Cloud management tools to read database records one by one. Accordingly, in preferred embodiments, the database of the client-server network has additional safeguards.

Data in many modern databases (“No-SQL database”) is stored in clear text in pairs of Key and Value, such as: ID: “123456”, Name: “John”, Phone: “03-11223344.” By contrast, in embodiments of the disclosed system, the values in the database are encrypted, so “ID: 123456” will be “ID: {A4rfgY5 s}.” When it is necessary to search the database for this record, the database will be asked to look for the encrypted value “{A4rfgY5s}”. This is search in encrypted space.

When it is desired to search for a range, for example a timestamp, the full time is encrypted, and also there will be another field that is not encrypted but missing information. Thus, “Time: Jun. 1, 2022 19:04:03.004” will become two entries: “Time: {fv9d3REertioje4rdf}” and “Timestamp: Jun. 1, 2022 Q4” where Q4 means 4th quarter of the day. The function of the additional appellation “Q4” will be explained further herein.

When data is encrypted, every datatype has a dedicated encryption key. This means that “UserID: 1234” in an employee table becomes “UserID: {Rt4F}” and the same user has a different encrypted ID in the salary table “UserID: {#aQw}”. When searching the tables, a valid user decrypts and encrypts again and always searches in encrypted space. But, an attacker will read the data in the two tables and will not have a way of knowing which UserID in one table is related to the UserID in the other table.

Relatedly, an attack on a database may involve setting predefined data that will weaken the encryption. For example, the attacker may set email addresses to 0000000000000@gmail.com. When this attacker captures the database at a later time, she can find the record by creation date and try to deduce the encryption key by knowing both encrypted and decrypted values of the database field. To avoid this, on top of the encryptions mentioned above, it is possible to encrypt with a key that is unique to each database tenant (i.e., an organization). This way the data of every customer is encrypted using a dedicated encryption key, so even if the encryption key used for every database table is compromised, the data of all customers still remains secure. It is also possible to use a dedicated encryption key for every table and every tenant, instead of using a fixed key for a database table and one key for a tenant, so that if there are 8 tables, every tenant would have 8 encryption keys, one for every database table.

As another form of database protection, generally, an attacker may assume that records of different tables are created together. For example a record of “new message to user” and another record of “message status: just created”. Even though UserID is different it is clear that both records were created at the same time and appear one after the other in the database file. For this reason, in advantageous embodiments, when a message record is created, a wait is imposed creating the status record. The message status record is created only after the first update. The creation timestamp is also never left in clear text. In order to enable searching based on time stamp, the clear text timestamp has only partial information, as discussed above.

The system further differentiates between searchable (indexed) data and data that will only be retrieved. For example, it may be desirable to search the employee table for all employees called “John” but it is not necessary to search for an employee by date of birth. When encrypting searchable data we make sure that it is always the same, for example “John” will always be encrypted to “{5F % 6fe2}”, but when encrypting non-searchable data a pre-fix may be added to the data with some random information. For example “Jun. 1, 2022” will be converted to “34524-Jun. 1, 2022” before encryption which will result in “{#rigu389}.” The next time the same information is encrypted, a different random prefix is appended, for example 05863-Jun. 1, 2022″ which will result in “{_945SDDF}” after encryption. This way even if the same information is encrypted using the same encryption key, an attacker cannot find any connection between the two records.

These techniques may be used as well for data that stays in computer memory (cache), whenever possible.

As another precaution, data may not be stored in a database if there is no need to recall it. User identifiers such as user id, organization id, login email may be stored in the regular fashion. By contrast, if it is desired to know that a user's phone number changed but it is not necessary to know what the original number was, only a hash of the phone number may be stored. When scanning a user's data, the system may generate hashes for most fields and compare the new hash with the previous hash for every field. This way even if an attacker got hold of the data and the encryption keys that were used, the customer's data will still be safe.

Encryption of data between the client and server may proceed in one of the following ways. First, the server may have a private key and the client may have a public key. If the attacker takes over the client account including the public key, the attacker will be able to read everything that the client is able to read, but will not be able to impersonate the server. Alternatively, a symmetric key may be used. The same key is used on both the client and the server. A key-base is then used during communication between the client and server. The key base may contain either part of the installation of an application on the client device, and may contain data sent to the application the first time the application is running. An algorithm written in the code of the device performs mathematical and logical manipulation of the key-base in order to get the real encryption key. Thus, the key may be used by the App, but the key is not part of the App's installation package. Since the encryption is symmetric, the same key base and algorithms are implemented on the server, so that the server also has the run-time generated key.

### Communication Security

Another form of protection, in preferred embodiments, concerns securing communications between clients and servers. Generally, clients communicate with servers using HTTP requests (aka REST API). The data is encrypted but the URL addresses are clear text. An attacker can identify the type of a client (PC, mobile device, another server) by analyzing the URLs in use. An attacker can also understand the state of the client by parsing the URLs. For example if a client is making a request to URL “https://api.our-domain.com/API/admin/users”, it is clear that the client is a management system. If the address is “https://api.our-domain.com/API/emergency”, it is clear that someone detected the breach and has reported about it which started the emergency protocol. APIs look like this because different URLs are owned by different software modules and services.

Communication URL is clear text and communication payload (data) is encrypted but an attacker that has hold of network infrastructure may be able to decode (or fool) SSL encryption.

Even without understanding the content of requests it might be possible to identify the type of client and detect the state of the client by analyzing network behavior. For example a server may ask for updates every 5 minutes; a device may send a request every 30 minutes but if a breach was detected, it will send a sequence of 2 short and 3 long messages.

In exemplary embodiments, all requests use the same URL, e.g., “ . . . /api/package.” encrypted data inside the payload describes the real operation that is performed, and the ‘package’ module dispatches the message to the correct module (behaving like what is called an API Gateway).

Devices may start “emergency” communication with a special tag “just a drill”, so that attackers cannot rely on understanding this behavior as ‘breach detected.”

Devices may also encrypt sensitive data on top of the SSL encryption. In addition, a random data prefix may be used to change the request data so that the same request is not always the same encrypted request. It is possible to change the length of the prefix so that same requests will have different length of encrypted data.

As another form of communication protection, devices do not use a fixed period of time for communication (for example every 5 minutes), instead some random time is added so requests will be between 3 to 8 minutes. This way an attacker cannot know how many devices are active inside the network just by listening to the communication to the server. When a device is restarted, it will choose a random number, for example between 3 to 8 minutes and then all communications will be around that number, so a device that picked 4 will use 3 to 5 and a device that picked 6 will use 5 to 7. Otherwise statistics will align and the attacker will know how many devices are in the network simply by looking at the average.

What is claimed is:

1. A computer system running responsible artificial intelligence software configured to engage in a collaboration process with one or more responsible users in a process of making a responsible decision, wherein:
the computer system is configured to receive inputs from users and generate outcomes and perform actions;
the responsible artificial intelligence has legal or moral accountability derived from one or more of authorization or assumption of responsibility;
the one or more responsible users is selected on a basis of one or more of the following criteria: knowledge of truth; impact of mistake on said user; legal owner of a resource;
accountability for system activity or error; role in organization; designation as responsible user for a given situation; or custody of physical or digital asset; and
the collaboration process is a process by which the system selects one or more responsible users and contacts said one or more responsible users to support a decision made by an artificial intelligence by providing one or more of information, knowledge, or approval of the responsible decision prior to acting on the decision;
the process of making a responsible decision comprises a decision to perform an action that has direct consequences on one or more of a legal entity, a living creature, or the physical world, outside of the computer system.

2. The computer system of claim 1, wherein the responsible decision relates to an event that has one or more of the following statuses: under investigation; cleared; or flagged.

3. The computer system of claim 2, wherein the collaboration process comprises issuing at least one query to each of the one or more responsible users regarding whether the event is authorized by prompting each of the identified responsible users to select from one of the following three tags: (1) “Clear,” signifying approval of the event; (2) “Flag,” signifying disapproval of the event; and (3) “Dismiss,” signifying referral of the event to others; and, based on the responses of the one or more responsible users, either approving the event or flagging the event as potentially unauthorized.

4. The computer system of claim 3, wherein the collaboration process further comprises following flagging of the event as potentially unauthorized, creating a group conversation with a plurality of responsible users, and, within the group conversation, providing relevant information; responding to requests by group members and providing requested information; providing information to members of the group; taking actions requested by responsible users in the group; and reporting to the group of decisions and activities taken autonomously.

5. The computer system of claim 3, wherein the event is one or more of the following: a change in a user account; a change in data; a change in configuration; a change in organization data and structure; an action performed by a computer system; an action performed by a physical device controlled by a computer system; an autonomous activity; a decision made by an artificial intelligence; a transfer of funds; a request in an application programming interface.

6. The computer system of claim 3, wherein the event is an activity performed by another computer system that is monitored or supervised by the responsible artificial intelligence software.

7. The computer system of claim 1, wherein the one or more responsible users are selected based on the following criteria: specific person; relation to specific person; role in organization; or responsibility in organization.

8. The computer system of claim 7, wherein the one or more responsible users include an artificial intelligence that has been authorized to respond by another responsible user.

9. The computer system of claim 7, wherein the computer system is configured to define roles of users within an organization and relation of users to specific persons within an organization based on one or more of the following processes: scanning organizational data; communicating with organizational systems; communicating with external systems; collecting and processing information in messaging applications and social media; requesting and receiving input from a responsible user; receipt of manual input by a person using a user interface; and analyzing information from formatted data and document.

10. The computer system of claim 1, further comprising a policy editor tool configured to define policy and guidelines for the process of making a responsible decision, including one or more of: preferred actions; preferred responsible users; tilt weight of decisions made by artificial intelligence; and actions to take until and following responses of responsible users.

11. The computer system of claim 1, further comprising a system for verifying identities of responsible users using multi-factor verification.

12. The computer system of claim 11, wherein the collaboration process comprises crowd sourcing to multiple responsible users.

13. The computer system of claim 11, wherein the system for verifying is configured to communicate with each responsible user via multiple devices.

14. The computer system of claim 11, wherein the system for verifying is configured to communicate with each responsible user via multiple user accounts.

15. The computer system of claim 11, wherein the system is configured to send multiple notifications to each responsible user for each event.

16. The computer system of claim 1, wherein the decision is made by an artificial intelligence that is one or more of: an operating system of a physical device; a virtual employee; or a virtual or physical cloud-based machine.

17. The computer system of claim 1, further comprising a policy engine for making a decision on activities before and after responses by the one or more responsible users, wherein the policy engine is configured, on the basis of responses by the one or more responsible users, to one or more of: take action; contact other responsible users; declare an emergency situation; and act to mitigate and reduce damages.

18. The computer system of claim 1, wherein the collaboration process includes contacting each responsible user on a specific device identifying said responsible user, wherein only one device is available for contacting each responsible user at any given time.

19. The computer system of claim 1, wherein the computer system is configured to implement user instructions regarding flagging or prevention of use of data or functionalities prior to completion of the collaboration process, said user instructions comprising one or more of: flagging data fields in a database; flagging a user account; flagging data and actions in a user interface tool; hiding data from an application programming interface and from a user interface tool; disabling activity in an application user interface or user interface tool; or requiring an extended validation process to perform an action or use data.

20. A software platform for enabling communication between the computer system of claim 1 and the one or more responsible users.

21. The software platform of claim 20, wherein the communication is performed by identifying the one or more responsible users with multi-factor verification.

22. The software platform of claim 20, wherein the communication with each responsible user includes prompting each of the identified responsible users to select from one of the following three tags: (1) “Clear,” signifying approval of the event; (2) “Flag,” signifying disapproval of the event; and (3) “Dismiss,” signifying referral of the event to others.

23. An artificial intelligence-based security software configured to function as a responsible user in the system of claim 1.

24. A method of cybersecurity, comprising:
detecting a decision made by an artificial intelligence to perform an action that has direct consequences on one or more of a legal entity, a living creature, or the physical world, outside of the computer system;
selecting one or more responsible users to support the decision made by the artificial intelligence by providing one or more of information, knowledge, or approval of the responsible decision prior to acting on the decision;
performing a collaboration process with the selected one or more responsible users, wherein the collaboration process comprises issuing at least one query to each of the one or more responsible users regarding whether the event is authorized by prompting each of the identified responsible users to select from one of the following three tags: (1) “Clear,” signifying approval of the event; (2) “Flag,” signifying disapproval of the event; and (3) “Dismiss,” signifying referral of the event to others; and, based on the responses of the one or more responsible users, either approving the event or flagging the event as potentially unauthorized.

25. The method of claim 24, wherein the selecting step comprises selecting multiple people, at least some of which are not responsible for cybersecurity.

26. The method of claim 24, wherein the event comprises one or more of the following: a change in organization structure; a change in user account details; a change in user account access rights and authorization; a change in employee contact information; a change in employee data; a change in a device identifying a user; a change in a device controlling a vehicle or an artificial intelligence; a change in email rules; or a change in ownership of a digital asset.

27. The method of claim 24, wherein the detecting step comprises detecting changes in user accounts with an Active Directory scanner.

28. The method of claim 24, further comprising engaging in protective measures prior to, and after, receiving a notification of a flag of an event.

29. The method of claim 24, wherein the process of issuing a query comprises establishing a secure connection between a device and a server, wherein the step of establishing a secure connection comprises adding a random prefix to a text and data buffer, so that repeating encryption of the same buffer will result in a different encrypted data buffer.

30. The method of claim 29, wherein the step of establishing a secure connection further comprises manipulation of an encryption key in code before using the key, so that both source code and the encryption key are required to decrypt a buffer.

31. A method for verification of an event initiated by an artificial intelligence, comprising:
detecting an event requiring authorization, wherein the event is a potential action that is autonomously determined to be performed by the artificial intelligence;
identifying one or more users that are responsible for authorizing the event;
issuing at least one query to each of the one or more responsible users regarding whether the event is authorized; and
based on the responses of the one or more responsible users, either approving the event or flagging the event as potentially unauthorized.

32. The method of claim 31, wherein the step of issuing at least one query comprises prompting each of the identified responsible users to select from one of the following three tags:
(1) “Clear,” signifying approval of the event; (2) “Flag,” signifying disapproval of the event; and
(3) “Dismiss,” signifying referral of the event to others.

33. The method of claim 32, further comprising, if all identified responsible users select the “Dismiss” tag, flagging the event.

34. The method of claim 31, wherein, when the one or more responsible users comprises either a single user, or a single supervisory user, prompting the single user or the single supervisory user to select from one of the following two tags: (1) “Clear,” signifying approval of the event; or (2) “Flag,” signifying disapproval of the event.

35. The method of claim 31, further comprising, before the responses are received, or based on the responses received, performing one or more protective measures to prevent unauthorized control of the computer system.

36. The method of claim 31, wherein the flagging step comprises referring the event to supervisory review.

37. The method of claim 31, wherein the event comprises one or more of: (1) addition of a new employee; (2) a change in access rights to the network; or (3) a change in authorization on financial controls.

38. The method of claim 31, wherein the artificial intelligence is an operating system of an autonomous robot, autonomous machine, or autonomous virtual assistant.

39. The method of claim 31, wherein the artificial intelligence is configured within a computer system that is a server of a client-server network.

40. The method of claim 31, wherein the issuing step comprises issuing each query to a particular user device that had been previously linked to said responsible user through installation of a unique device key on said user device.

41. The method of claim 31, wherein the issuing step comprises issuing each query to a plurality of user devices simultaneously, and requiring the responsible user to reply to the query on each device.

42. The method of claim 31, wherein the issuing step comprises initiating communication to each responsible user using multi-factor authentication.

43. The method of claim 31, wherein the issuing step comprises initiating communication to each responsible user using multi-factor identification, in which the user is required to access two secure accounts simultaneously.

44. The method of claim 31, wherein the identifying step comprises selecting one or more responsible users on a basis of one or more of the following criteria:
legal owner of a resource;
accountability for system activity or error;
role in organization; or
custody of physical or digital asset.

45. The method of claim 44, wherein the step of selecting one or more responsible users comprises selecting an artificial intelligence, said artificial intelligence having been authorized to respond by another responsible user.

46. The method of claim 44, wherein at least one of said responsible users does not have responsibility for cybersecurity within the organization.

47. The method of claim 44, wherein the identifying step comprises crowdsourcing the verification to multiple responsible users, at least one of which lacks responsibility for cybersecurity within the organization.

48. The method of claim 31, further comprising preventing execution of the decision until the responses are received.

49. The method of claim 31, wherein the event is performance of an action that has direct consequences on one or more of a legal entity, a living creature, or the physical world, outside of a computer system.
